(19) United States
(12) Patent Application Publication
(10) Pub. No.: US 2025/0156057 A1
(43) Pub. Date: May 15, 2025

(54) INFORMATION PROCESSING DEVICE AND INFORMATION PROCESSING METHOD

(71) Applicant: Faurecia Clarion Electronics Co., Ltd., Saitama-shi (JP)

(72) Inventors: Takuma SHIOGUCHI, Saitama (JP); Keiichiro YOSHIHARA, Saitama (JP); Kenta YASUTOMO, Saitama (JP); Jun KAWANO, Saitama (JP); Takahiro UEMURA, Saitama (JP)

(73) Assignee: Faurecia Clarion Electronics Co., Ltd., Saitama-shi (JP)

(21) Appl. No.: 18/945,250

(22) Filed: Nov. 12, 2024

(30) Foreign Application Priority Data
Nov. 13, 2023 (JP) 2023-192878

(51) Int. Cl. G06F 3/04847; G06F 3/0488

(52) U.S. Cl. CPC G06F 3/04847; G06F 3/0488

(57) ABSTRACT

To improve operability when changing the display layout. An information processing device connected to a display and a touch panel contains: a touch operation detecting unit; a display control unit controlling a display signal output to the display for displaying a reduced layout screen that displays an arrangement of the plurality of display contents, and allows the arrangement of the plurality of display contents to be changed when a predetermined operation is detected; and operation position determining unit that determines whether the user is operating from the left or right; wherein the display control unit displays the layout screen on the left side of the display when the predetermined operation is determined to have been performed from the left side of the display, and the display control unit displays the layout screen on the right side of the display when the predetermined operation is determined to have been performed from the right side of the display.

### FIELD OF THE INVENTION

The present invention relates to an information processing device and an information processing method for controlling display on the display.

### CONVENTIONAL TECHNOLOGY

Technology for changing the display layout on a display is disclosed in Patent document 1. Patent Document 1 states that “when resizing or moving a window, a mouse must be moved significantly while dragging”, and “The system includes layout window displaying means for reducing the entire screen displayed in an original window 1 and displaying as a layout window 3, relative position calculating means for calculating the relative position of the original window with respect to the entire screen, and image window displaying means for displaying the original window relatively positioned in the layout window by the relative position calculating means as an image window 4, wherein the original window is resized and moved by dragging the image window with a mouse pointer 2”.

### PRIOR ART DOCUMENTS

### Patent Documents

Patent Document 1: Japanese Unexamined Patent Application Publication H10-293674

### SUMMARY OF THE INVENTION

### Problem to be Solved by the Invention

With the aforementioned conventional technology, the amount of mouse movement is reduced, thereby improving operability. However, the aforementioned conventional technology does not take into consideration various use cases of displays. For example, in a use case where a wide touch panel display is used and the position of the user is limited, the range in which the user can touch and operate the display with their hands may be limited. One specific example is a case in which a touch panel display is installed across the left and right sides of a dashboard at a front of a vehicle and is operated by a driver and passenger in front seats. The display installed on the dashboard can display a variety of content, including instruments such as the speedometer, maps, video, and the like. Moreover, displays are required to be able to change the layout of the content they display. In particular, when a vehicle occupant operates an in-vehicle display, ensuring high operability is important from the perspective of vehicle driving safety.

An object of the present invention is to improve operability related to changing the layout of a display.

### Means for Solving the Problem

In order to achieve the aforementioned object, one typical information processing device is an information processing device connected to a display and a touch panel overlaid on the display, including: a touch operation detecting unit that detects an operation on the touch panel by a user; an application executing unit that executes a plurality of applications; a display control unit that controls a display signal output to the display of a plurality of display contents generated by executing a plurality of applications by the application executing unit, such that the display content allocation can be changed in accordance with an operation by a user when a predetermined operation is detected on the touch panel by the touch operation detecting unit, and a layout screen that displays a reduced arrangement of the plurality of display contents can be displayed; and an operation position determining means for determining whether the user is operating from the left or right direction; wherein the display control unit displays the layout screen in a first layout region located on the left side of the display when the operation position determining means determines that the predetermined operation was performed from the left side of the display; and displays the layout screen in a second layout region located on the right side of the display when the operation position determining means determines that the predetermined operation was performed from the right side of the display.

### Effect of the Invention

The present invention can improve operability related to changing a display layout. The following description of the embodiments will elucidate the problems, configurations, and effects other than those described above.

### BRIEF DESCRIPTION OF THE DRAWINGS

FIG. 1 is an explanatory diagram depicting a layout screen by an information processing device according to embodiment 1;

FIG. 2 is a configuration diagram of the entire system of embodiment 1;

FIG. 3 is an explanatory diagram of a detection region and a layout region;

FIG. 4 is a flow chart for displaying a layout screen;

FIG. 5 is an explanatory diagram of a layout change process; and

FIG. 6 is a flow chart of a layout change process.

### EMBODIMENTS OF THE INVENTION

Next, an embodiment of the present invention will be described using drawings.

### Embodiment 1

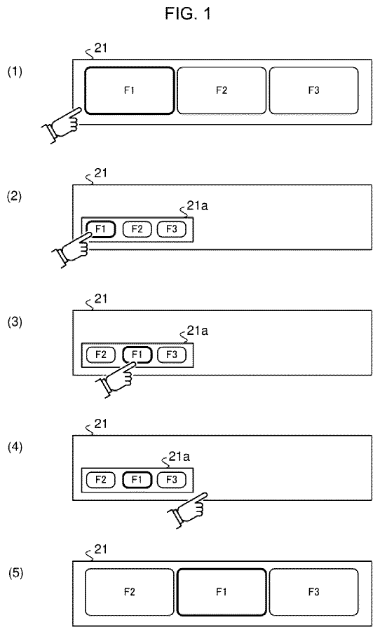

FIG. 1 is an explanatory diagram depicting a layout screen by an information processing device according to embodiment 1. An information processing device 30, which will be described later, controls the display on a display 21 installed in the vehicle.
The display 21 is installed across the left and right sides of the dashboard at the front of the vehicle.
In this specification, left and right are described based on the state facing the traveling direction of the vehicle.
A touch panel 22, which will be described later, is overlaid on the display 21.
The information processing device 30 executes a plurality of applications. The information processing device 30 controls a display signal to the display 21, so as to display a plurality of display contents generated by executing a plurality of applications on the display 21, respectively.
In FIG. 1(1), the display 21 displays display contents F1 to F3 in a horizontal row in order of “F1”, “F2”, and “F3”, from the left.

When the information processing device 30 detects a predetermined operation on the touch panel 22, the information processing device displays the layout screen 21a (2). The predetermined operation is, for example, a long press on a predetermined region. Hereinafter, the predetermined operation is referred to as a specific operation. The layout screen 21a is a screen on which the arrangement of the display contents F1 to F3 can be changed in accordance with a user operation. The layout screen 21a is a display region in which the arrangement of the display contents F1 to F3 is displayed at a reduced scale. In other words, the layout screen 21a displays the screen depicted in FIG. 1(1) as is with reduced size.

The information processing device 30 can determine whether the user is performing the operation from the left or right direction based on the position where a specific operation is performed or a separately installed camera or sensor.
When the information processing device 30 determines that the specific operation has been performed from the left side of the display 21, the information processing device displays the layout screen 21a on the left side of the display 21. For example, a first layout region is set in advance on the left side of the display 21, and a layout screen 21a is displayed in the first layout region. Alternatively, the layout screen 21a may be displayed near the position where the specific operation is received.
When the information processing device 30 determines that the specific operation has been performed from the right side of the display 21, the information processing device displays the layout screen 21a on the right side of the display 21. For example, a second layout region is set in advance on the right side of the display 21, and a layout screen 21a is displayed in the second layout region. Alternatively, the layout screen 21a may be displayed near the position where the specific operation is received.
In FIG. 1(2), the information processing device 30 determines that the specific operation was performed from the left side of the display 21, and displays a layout screen 21a on the left side of the display 21.

The information processing device 30 receives an operation to change the arrangement of the display contents F1 to F3 on the layout screen 21a. When an operation of dragging the display content F1 to the right to the display position of the display content F2 is received, the information processing device 30 exchanges the positions of the display content F1 and the display content F2 (3).

When a predetermined end operation is received after the operation of changing the layout (3), the information processing device 30 terminates the display of the layout screen 21a, reflects the layout change, and cancels the display of the layout screen (4). The predetermined ending operation is, for example, an operation of long pressing outside of the layout screen 21a. When the display of the layout screen is canceled, the display contents F1 to F3 are displayed over the entire display 21. The layout change has been reflected here, so in FIG. 1(4), the display 21 displays the display contents F1 to F3 horizontally in the order of “F2”, “F1”, and “F3” from the left.

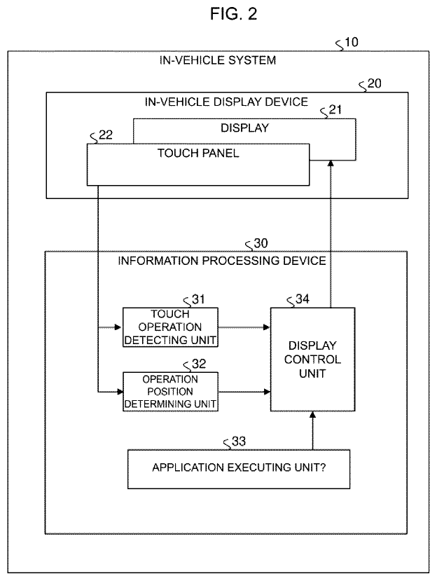

FIG. 2 is a configuration diagram of the overall system of embodiment 1.
The in-vehicle system 10 includes an in-vehicle display device 20 and an information processing device 30.
The in-vehicle display device 20 has a display 21 and a touch panel 22 laminated on the display 21.
The information processing device 30 is connected to a display 21 and a touch panel 22.
The information processing device 30 includes a touch operation detecting unit 31, an operation position determining unit 32, an application executing unit 33, and a display control unit 34.

The touch operation detecting unit 31 detects an operation on the touch panel 22 by the user from a detection signal from the touch panel 22.
The operation position determining unit 32 determines whether the user is operating from the left or right direction.
As an example, the operation position determining unit 32 determines from which direction the user is operating on the basis of whether the specific operation is performed in a predetermined first detection region on the left side of the display 21 or whether the specific operation is performed in a predetermined second detection region on the right side of the display.
As another example, the operation position determining unit 32 detects whether the user is operating from the left side or the right side by recognizing a human body using a camera or a sensor.

The application executing unit 33 executes a plurality of applications. The plurality of applications include an application that displays instruments such as a speedometer, an application that displays a map and provides route guidance, an application that plays video or music, and an application that receives and outputs television or radio signals.

The display control unit 34 displays a plurality of display contents each generated by the application executing unit 33 at a predetermined position, and controls the display signal output to the display 21 so as to display the layout screen 21a when a specific operation on the touch panel 22 is detected by the touch operation detecting unit 31. The layout screen 21a is a screen that displays, at a reduced scale, the arrangement of a plurality of display contents, allowing the arrangement of the plurality of display contents to be changed in accordance with a user operation.

When the operation position determining unit 32 determines that a specific operation has been performed from the left side of the display 21, the display control unit 34 displays the layout screen in a first layout region located on the left side of the display 21.
When the operation position determining unit 32 determines that a specific operation has been performed from the right side of the display 21, the display control unit 34 displays the layout screen in a second layout region located on the right side of the display 21.

The display control unit 34 controls the display signal to be output to the display 21 such that when a user performs a drag operation on the layout screen to move a first display content, which is one of a plurality of display contents, closer to an adjacent second display content, the size of the second display content is reduced, and when the distance traveled by the drag operation exceeds a predetermined distance, the positions of the first display content and the second display content are switched.
Furthermore, the display control unit 34 changes the reduction ratio of the second display content depending on the movement distance of the drag operation.
These operations will be described below in further detail.

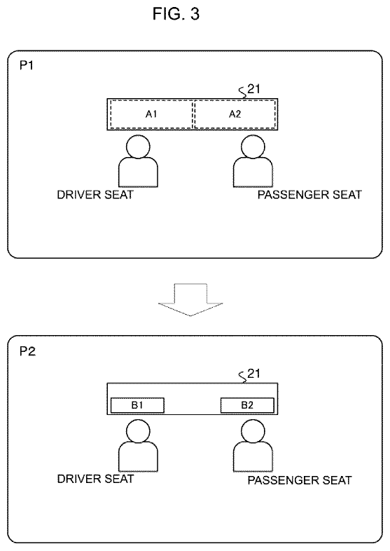

FIG. 3 is an explanatory diagram of a detection region and a layout region. At P1 in FIG. 3, the left side in the vehicle traveling direction is the driver seat and the right side is the passenger seat. A first detection region A1 is provided to the left of the display 21, within reach of a user sitting in the driver seat. A second detection region A2 is provided to the right of the display 21, within reach of a user sitting in the passenger seat.

When a specific operation is performed in the first detection region A1, the information processing device 30 establishes a first layout region B1 within reach of the user seated in the driver seat, as depicted by P2 of FIG. 3.
When a specific operation is performed in the second detection region A2, the information processing device 30 establishes a second layout region B2 within reach of the user sitting in the passenger seat.
As another example, the first detection region and the second detection region may be established in a blank region where the display contents F1 to F3 are not displayed, or may be in a dedicated region indicated by a button or the like. In these cases, the specific operation does not have to be a special touch operation such as a long press, but may be a single press touch operation.

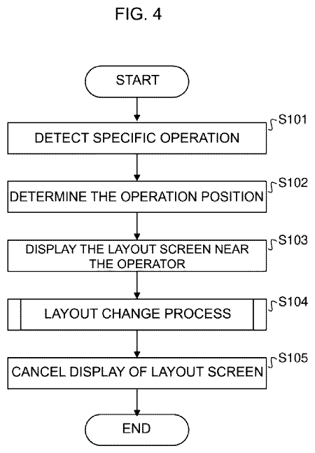

FIG. 4 is a flow chart depicting the display of the layout screen. The process of displaying the layout screen includes the following steps S101 to S105.
S101: The touch operation detecting unit 31 detects a specific operation on the touch panel 22. Thereafter, the process proceeds to Step S102.
S102: The operation position determining unit 32 determines whether the user is operating from the left or right direction. Thereafter, the process proceeds to Step S103.
S103: The display control unit 34 displays the layout screen in the vicinity of the user that is the operator. Thereafter, the process proceeds to Step S104.
S104: The display control unit 34 executes a layout change process for replacing or changing the size of the display contents on the basis of the operation detected by the touch operation detecting unit 31. Thereafter, the process proceeds to Step S105.
S105: The display control unit 34 cancels the display of the layout screen, reflects the changed layout on the entire display 21, and terminates the process.

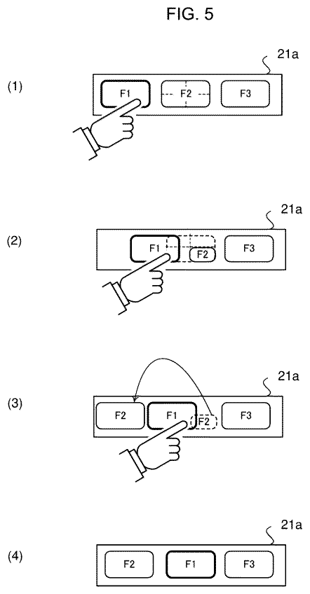

FIG. 5 is an explanatory diagram of the layout change process. In FIG. 5(1), in the initial state, display content F1 is displayed on the left side of the layout screen 21a, followed by display content F2, and display content F3 on the right side.

When the user drags the display content F1 to the right, the display content F1 moves to the right in accordance with the drag operation. Hereinafter, for convenience, the display content that is being moved in conjunction with the drag operation will be referred to as the “moving content”. Moreover, the display content existing at the destination of the moving content is called the destination content. In FIG. 5(1), the display content F2 is the destination content.

The moving content maintains size and shape while moving. When the moving content enters a region where the destination content was displayed, the destination content is reduced in size if the content can be reduced in size. This reduction frees up space for the moving content to enter, and prevents the moving content from overlapping with the destination content.

An example of a case where the destination content is reducible is a case where a plurality of display shapes of different sizes are provided as the content, and there is a display shape smaller than the current display shape. Another example is a case where the display size of the content can be arbitrarily enlarged or reduced within a predetermined range, and the content can be displayed smaller than the current display size.
In the example of FIG. 5(2), the display content F2, which is the destination content, is prepared in the display form depicted in FIG. 5(1) and a display form which is half the width and height of that form. Therefore, in FIG. 5(2), the image is displayed in a form in which the length and width are halved.

When the moving content moves further to the right and the destination content can no longer be reduced, the moving content and the destination content are switched, as depicted in FIG. 5(3). At this time, the size of the destination content becomes the size of the moving content before the moving content started to be moved.

After switching the content, when the user removes their finger from the moving content and performs a predetermined ending operation, the layout change is finalized. In FIG. 5(4), the displayed contents are switched to “F2”, “F1”, and “F3” in order from the left.

When a finger is released from the moving content in the state of FIG. 5(2), the displayed content F2, which is the destination content, maintains the reduced size. If an end operation is performed in this state, the display content F2 is confirmed as being reduced in size. In other words, the drag operation of the content being moved not only functions as a rearrangement operation, but also functions as a size change operation of the destination content. A single operation can perform a plurality of functions, allowing layout change operations to be executed simply and efficiently.

When the movement continues from the state of FIG. 5(2), if the destination content can be further reduced, the reduction of the destination content is repeated, as long as the destination content can be reduced.

If the movement continues from the state of FIG. 5(3), the display content F3 becomes the destination content. Therefore, it is possible to switch the display content F1 and the display content F3 and to change the size of the display content F3.

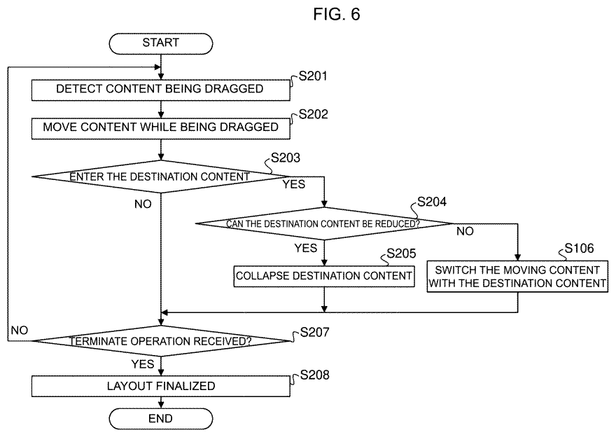

FIG. 6 is a flowchart of the layout change process. The layout change process includes the following steps S201 to S208.
S201: The touch operation detecting unit 31 detects dragging of display content on a layout screen. Thereafter, the process proceeds to Step S202.
S202: The display control unit 34 moves the display content in accordance with the dragging. The displayed content becomes the moving content. Thereafter, the process proceeds to Step S203.
S203: The display control unit 34 determines if the moving content enters the destination content or not. If not (S203; No), the process proceeds to step S207. If the moving content does enter the destination content (S203; Yes), the process proceeds to step S204.
S204: The display control unit 34 determines if the destination content can be reduced. If the destination content can be reduced (S203; Yes), the process proceeds to step S205. If the destination content cannot be reduced (S203; No), the process proceeds to step S206.
S205: The display control unit 34 reduces the destination content, and the process proceeds to step S207.
S206: The display control unit 34 switches the moving content with the destination content, and the process proceeds to step S207.
S207: The touch operation detecting unit 31 determines whether or not a predetermined end operation has been received. If the predetermined end operation has not been received (S207; No), the process returns to step S201. If a predetermined end operation has been received (S207; Yes), the process proceeds to step S208.
S208: The display control unit 34 confirms the layout and ends the layout change process. Thereafter, the process proceeds to S105 shown in FIG. 4.

As described above, the disclosed information processing device 30 is an information processing device connected to a display 21 and a touch panel 22 overlaid on the display 21, and includes a touch operation detecting unit 31 that detects operations on the touch panel 22 by a user, an application executing unit 33 that executes a plurality of applications, a display control unit 34 that controls a display signal output to the display so as to display at a predetermined position the plurality of display content generated by the application executing unit 33 executing the plurality of applications, and to display a layout screen that displays a reduced arrangement of the plurality of display contents when a predetermined operation on the touch panel is detected by the touch operation detecting unit 31, and an operation position determining unit 32 as operation position determining means for determining whether the user is operating from the left or right.
When the operation position determining means determines that a predetermined operation has been performed from the left side of the display 12, the display control unit 34 displays the layout screen in a first layout region located on the left side of the display, and when the operation position determining means determines that the predetermined operation was performed from the right side of the display 21, the display control unit displays the layout screen in a second layout region located on the right side of the display. Thereby, the layout screen will be displayed within reach of the user, and layout changes received on the layout screen can be reflected on the entire display, improving operability regarding changes to the display layout.

Furthermore, the display control unit 34 controls a display signal to be output to the display such that, when the user performs a drag operation on the layout screen to move a first display content, which is one of a plurality of display contents, closer to an adjacent second display content, the size of the second display content is reduced, and when the distance traveled by the drag operation exceeds a predetermined distance, the positions of the first display content and the second display content are switched.
Furthermore, the display control unit 34 changes the reduction ratio of the second display content depending on the movement distance of the drag operation.
Thereby, the size can be changed, and the arrangement can be switched by performing the same operation.

Furthermore, the operation position determining means detects whether the user is operating from the left side or is operating from the right side by recognizing a human body using a camera or a sensor.
With this configuration, highly accurate determination is possible by recognizing the state of the user.

Furthermore, the operation position determining means determines from which direction the user is operating based on whether the predetermined operation is performed in a predetermined first detection region on a left side of the display or whether the predetermined operation is performed in a predetermined second detection region on a right side of the display.
By using this operation, the operation direction can be determined by a simple configuration.

Furthermore, the display 21 is installed on both sides of a dashboard at a front of a vehicle, and the operation position determining means determines whether the user is operating the device from the left seat or the right seat.
This configuration improves operability when changing the layout of the in-vehicle display.

Furthermore, the display 21 is installed across the left and right sides of a dashboard at the front of the vehicle, the first detection region and the first layout region are within reach of a user sitting in a left seat, and the second detection region and the second layout region are within reach of a user sitting in a right seat.
This configuration improves operability when changing the layout of the in-vehicle display.

Note that the present invention is not limited to the abovementioned examples and includes various modified examples. For example, while the abovementioned examples have been described in detail in order to describe the present invention in an easy-to-understand manner, the present invention is not necessarily limited to those with all the described configurations. Moreover, not only the deletion of such configurations, but also the replacement or addition of configurations is possible.

For example, this may be implemented as an in-vehicle device having the function of the in-vehicle display device 20 and the function of the information processing device 30.

### DESCRIPTION OF SYMBOLS

10: In-vehicle system, 20: In-vehicle display device, 21: Display, 22: Touch panel, 30: Information processing device, 31: Touch operation detecting unit, 32: Operation position determining unit, 33: Application executing unit.

1. An information processing device connected to a display and a touch panel overlaid on the display, comprising:
a touch operation detecting unit that detects an operation on the touch panel by a user;
an application executing unit that executes a plurality of applications;
a display control unit that controls a display signal output to the display of a plurality of display contents generated by executing a plurality of applications by the application executing unit such that the display content allocation can be changed in accordance with an operation by a user when a predetermined operation is detected on the touch panel by the touch operation detecting unit, and a layout screen that displays a reduced arrangement of the plurality of display contents can be displayed; and
an operation position determining means for determining whether the user is operating from the left or right direction;
wherein
the display control unit
displays the layout screen in a first layout region located on the left side of the display when the operation position determining means determines that the predetermined operation was performed from the left side of the display; and
displays the layout screen in a second layout region located on the right side of the display when the operation position determining means determines that the predetermined operation was performed from the right side of the display.

2. The information processing device according to claim 1, wherein the display control unit controls a display signal to be output to the display such that, when the user performs a drag operation on the layout screen to move a first display content, which is one of a plurality of display contents, closer to an adjacent second display content, the size of the second display content is reduced, and when the distance traveled by the drag operation exceeds a predetermined distance, the positions of the first display content and the second display content are switched.

3. The information processing device according to claim 2, wherein the display control unit changes a reduction ratio of the second display content depending on a movement distance of the drag operation.

4. The information processing apparatus according to claim 1, wherein the operation position determining means detects whether the user is operating from the left side or is operating from the right side by recognizing a human body using a camera or a sensor.

5. The information processing device according to claim 1, wherein the operation position determining means determines from which direction the user is operating based on whether the predetermined operation is performed in a predetermined first detection region on a left side of the display or whether the predetermined operation is performed in a predetermined second detection region on a right side of the display.

6. The information processing device according to claim 1, wherein the display is installed on both sides of a dashboard at a front of a vehicle, and the operation position determining means determines whether the user is operating the device from the left seat or the right seat.

7. The information processing device according to claim 5, wherein the display is installed across the left and right sides of a dashboard at the front of the vehicle, the first detection region and the first layout region are within reach of a user sitting in a left seat, and the second detection region and the second layout region are within reach of a user sitting in a right seat.

8. An information processing method, comprising:
an application executing step in which an information processing device connected to a display and a touch panel overlaid on the display executes a plurality of applications;
a touch operation step where the information processing device detects an operation on the touch panel by the user;
an operation position determining step in which the information processing device determines whether the user is performing an operation from the left or right direction; and
a display control step of controlling a display signal to be output to the display so that the information processing device displays a plurality of display contents generated by executing the plurality of applications at predetermined positions, and displays a layout screen in which an arrangement of the plurality of display contents is displayed at a reduced scale and the arrangement of the plurality of display contents can be changed in accordance with an operation by the user, when a predetermined operation on the touch panel is detected;
wherein
the display control step includes:
displaying the layout screen in a first layout region located on the left side of the display when it is determined that the predetermined operation has been performed from the left side of the display; and
displaying the layout screen in a second layout region located on the right side of the display when it is determined that the predetermined operation is performed from the right side of the display.
